(19) United States
(12) Patent Application Publication
(10) Pub. No.: US 2015/0137721 A1
(43) Pub. Date: May 21, 2015

(54) POWER TOOL

(71) Applicant: MAKITA CORPORATION, Anjo-shi (JP)

(72) Inventors: Hirokatsu YAMAMOTO, Anjo-shi (JP); Takaaki OSADA, Anjo-shi (JP)

(21) Appl. No.: 14/518,301

(22) Filed: Oct. 20, 2014

(30) Foreign Application Priority Data
Nov. 21, 2013 (JP) 2013-241199

(51) Int. Cl. H02P 6/08; H02P 7/28

(52) U.S. Cl. CPC H02P 6/08; H02P 7/28
USPC 318/400.15; 318/432

(57) ABSTRACT

A power tool comprises a motor, an output torque calculation unit configured to calculate an output torque of the motor based on a current flowing through the motor, a friction torque calculation unit configured to calculate a friction torque of the motor based on a rotation speed of the motor, a load torque estimation unit configured to estimate a load torque acting on the motor, an inertia torque calculation unit configured to calculate an inertia torque based on the output torque, the friction torque and the load torque, and a motor deceleration unit configured to stop or decelerate the motor when the inertia torque is greater than an inertia torque reference value.

### CROSS-REFERENCE TO A RELATED APPLICATIONS

This application claims priority to Japanese Patent Application No. 2013-241199 filed on Nov. 21, 2013, the contents of which are hereby incorporated by reference into the present application.

### TECHNICAL FIELD

The present teachings disclosed herein relate to power tools.

### DESCRIPTION OF RELATED ART

International Publication No. WO 2012/108246 A1 discloses a power tool including a motor and a load torque estimation unit configured to estimate a load torque acting on the motor. This power tool makes it possible, without using a torque sensor, to estimate a load torque acting on the motor.

### BRIEF SUMMARY OF INVENTION

In case of an abrupt rise in load, such as case of a kickback having occurred during work being done using a power tool, it is preferable, in order to ensure the safety of the user, that the motor be stopped or decelerated. A technology is disclosed herein which makes it possible to stop or decelerate the motor in case of an abrupt rise in load.

In one aspect of the present teachings, a power tool includes: a motor; an output torque calculation unit configured to calculate an output torque of the motor based on a current flowing through the motor; a friction torque calculation unit configured to calculate a friction torque of the motor based on a rotation speed of the motor; a load torque estimation unit configured to estimate a load torque acting on the motor; an inertia torque calculation unit configured to calculate an inertia torque based on the output torque, the friction torque and the load torque; and a motor deceleration unit configured to stop or decelerate the motor when the inertia torque is greater than an inertia torque reference value.

In the power tool, with attention focused on the fact that the inertia torque of the motor takes on a great value when the load abruptly rises, the motor is stopped or decelerated when the inertia torque is greater than the inertia torque reference value. This makes it possible to ensure the safety of the user. Further, in the power tool, the motor will not be stopped or decelerated when the load torque is high but the inertia torque is low, e.g. during normal heavy-load work. This makes it possible to suppress a decrease in working efficiency.

### BRIEF DESCRIPTION OF DRAWINGS

FIG. 1 schematically shows a configuration of a power tool 2 of an embodiment;

FIG. 2 schematically shows a configuration of a voltage detection unit 32 of the embodiment;

FIG. 3 is a block diagram showing an example of a configuration of a load torque estimation circuit 16 of the embodiment;

FIG. 4 is a block diagram showing a configuration of a combination of the load torque estimation circuit 16 of FIG. 3 and a motor 8;

FIG. 5 is a block diagram showing a control system equivalent to a control system of FIG. 3;

FIG. 6 is a block diagram showing another example of a configuration of a load torque estimation circuit 16 of the embodiment;

FIG. 7 is a block diagram showing still another example of a configuration of a load torque estimation circuit 16 of the embodiment;

FIG. 8 is a block diagram showing still another example of a configuration of a load torque estimation circuit 16 of the embodiment;

FIG. 9 is a flow chart explaining an example of a process that is performed by a controller 18 of the embodiment; and

FIG. 10 is a flow chart explaining another example of a process that is performed by the controller 18 of the embodiment.

### DETAILED DESCRIPTION OF INVENTION

In a power tool according to some embodiments, the load torque estimation unit may be configured to estimate the load torque based on at least two of a measured value of the current flowing through the motor, a measured value of a terminal voltage of the motor and a measured value of the rotation speed of the motor. The current flowing through the motor, the terminal voltage of the motor, and the rotation speed of the motor are detectable with a conventionally-used small-sized and inexpensive detection mechanism. This power tool makes it possible, without incurring an increase in size or a rise in cost, to estimate the load torque acting on the motor.

A power tool according to some embodiments may be configured to further include a rotation speed estimation unit configured to estimate the rotation speed of the motor based on a measured value of the current flowing through the motor and a measured value of a terminal voltage of the motor. This power tool makes it possible, without using a rotation speed sensor configured to detect the rotation speed of the motor, to calculate the friction torque of the motor by estimating the rotation speed of the motor.

In a power tool according to some embodiments, the motor deceleration unit may be configured not to stop or decelerate the motor when the load torque is less than a load torque reference value or the output torque is less than an output torque reference value, even when the inertia torque is greater than the inertia torque reference value. During low-load work in which the load torque or the output torque is low, an abrupt rise in load during work being done using the power tool, if any, is less of a problem for the safety of the user. The power tool will not stop or decelerate the motor when the load torque or the output torque is low, even when the inertia torque becomes higher due to an abrupt rise in load. This configuration makes it possible to suppress a decrease in working efficiency.

The power tool may be configured such that a combination of the load torque reference value or the output torque reference value and the inertia torque reference value is selectable from a plurality of predetermined combinations by a user. This configuration allows the user to change the settings for the power tool as appropriate according to the purpose for which the power tool is used.

A power tool according to some embodiments may be configured to further include a removable side handle. Normally, a power tool including a removable side handle is used for heavy-load work in which a high load torque acts. During heavy-load work, it is of extreme importance to ensure the safety of the user when there is an abrupt rise in load. This power tool makes it possible to ensure the safety of the user during heavy-load work.

A power tool according to some embodiments may be configured such that the motor is a brushless motor. Normally, a brushless motor can be quickly decelerated or stopped as its rotor has a low inertia moment. This power tool makes it possible to rapidly decelerate or stop the motor when there is an abrupt rise in load.

In a power tool according to some embodiments, the motor deceleration unit may be further configured to stop or decelerate the motor when the load torque is greater than a load torque upper limit value. This power tool makes it possible to achieve the function of a driver completing screw tightening at a predetermined torque, as in the case where a mechanical clutch is used. As compared with the mechanical clutch, the electric clutch thus achieved neither generates sounds during operation nor deteriorates due to wearing.

The power tool may be configured to further include a mode switching unit configured to select an operation mode of the power tool from a plurality of operation modes, wherein the motor deceleration unit may be configured not to stop or decelerate the motor when a specific operation mode is selected, even when the load torque is greater than the load torque upper limit value. This configuration allows the user to select whether or not to enable the electric clutch according to the purpose for which the power tool is used.

The power tool may be configured to further include a notification unit configured to notify a user when the motor deceleration unit stops or decelerates the motor. This configuration allows the user to recognize that the motor is decelerated or stopped to ensure the safety.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved power tools, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EMBODIMENT

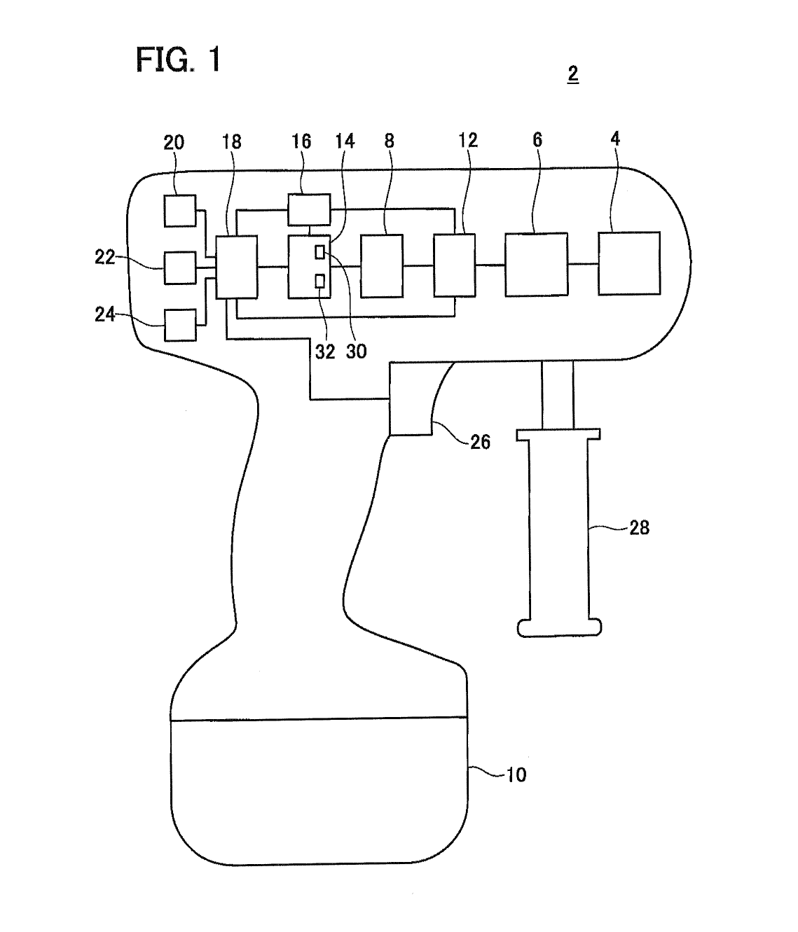

As shown in FIG. 1, a power tool 2 of the present embodiment includes a tool unit 4, a power transmission unit 6, a motor 8, a battery 10, a rotation speed sensor 12, a motor drive circuit 14, a load torque estimation circuit 16, a controller 18, a mode switching unit 20, a torque setting unit 22, a notification unit 24, a driving switch 26, and a side handle 28. The power tool 2 of the present embodiment is for example a driver drill.

In the power tool 2, the motor drive circuit 14 is configured to drive the motor 8 to rotate, and the power transmission unit 6 is configured to transmit the rotation of the motor 8 to the tool unit 4. The rotation speed sensor 12 is configured to detect a rotation speed ω of the motor 8. When the motor 8 is a DC brushless motor, the rotation speed sensor 12 may be a rotation speed sensor that the motor 8 structurally includes. The motor drive circuit 14 includes a current detection unit 30 configured to detects a current flowing through the motor 8 and a voltage detection unit 32 configured to detect a terminal voltage of the motor 8.

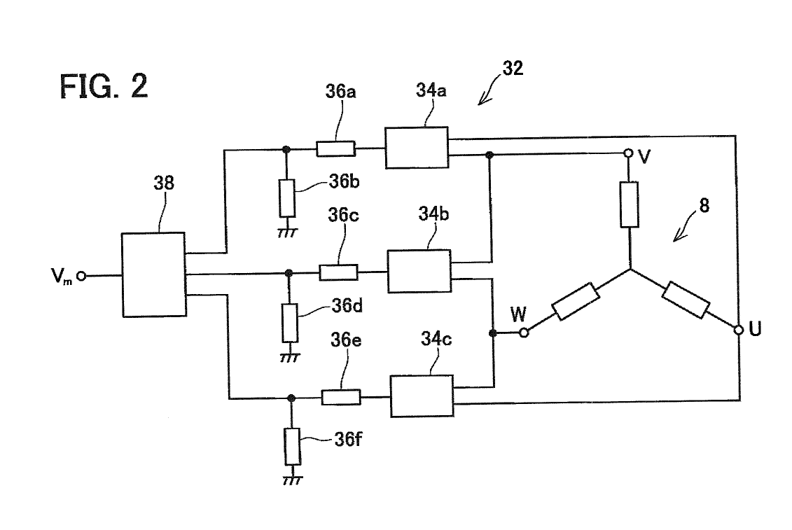

FIG. 2 shows an example of how the voltage detection unit 32 is configured when the motor 8 is a three-phase DC brushless motor. The voltage detection unit 32 includes difference circuits 34a, 34b, and 34c, resistors 36a, 36b, 36c, 36d, 36e, and 36f, and an adder 38. The difference circuit 34a is configured to output a voltage between a U phase of the motor 8 and a V phase of the motor 8. The output from the difference circuit 34a is divided by the resistors 36a and 36b and inputted to the adder 38. The difference circuit 34b is configured to output a voltage between the V phase of the motor 8 and a W phase of the motor 8. The output from the difference circuit 34b is divided by the resistors 36c and 36d and inputted to the adder 38. The difference circuit 34c is configured to output a voltage between the W phase of the motor 8 and the U phase of the motor 8. The output from the difference circuit 34c is divided by the resistors 36e and 36f and inputted to the adder 38. The adder 38 is configured to add together the inputs from the difference circuits 34a, 34b, and 34c and output the inputs thus added together. In the present embodiment, the output from the adder 38 is used as a measured value Vₘ of the terminal voltage of the motor 8. It should be noted that the difference circuits 34a, 34b, and 34c, the resistors 36a, 36b, 36c, 36d, 36e, and 36f, and the adder 38 may be mounted as circuits that are separate from the controller 18 or may be incorporated into the controller 18.

The load torque estimation circuit 16 of FIG. 1 is configured to estimate a load torque acting on the motor 8 from the tool unit 4 through the power transmission unit 6.

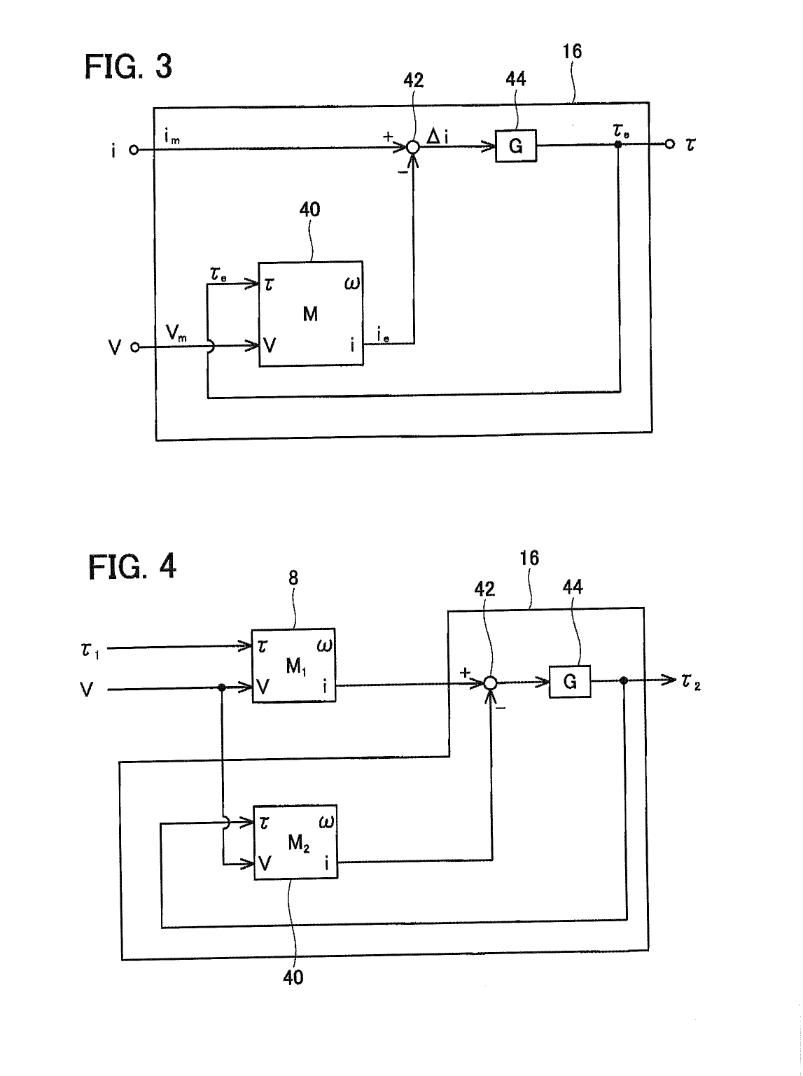

FIG. 3 shows an example of a configuration of the load torque estimation circuit 16. The load torque estimation circuit 16 of FIG. 3 is configured to output an estimated value τₑ of the load torque acting on the motor 8 based on a measured value iₘ of the current flowing through the motor 8 as detected by the current detection unit 30 and the measured value Vₘ of the terminal voltage of the motor 8 as detected by the voltage detection unit 32. The load torque estimation circuit 16 includes a motor model 40, a comparator 42, and an amplifier 44.

The motor model 40 is a modelization of the characteristics of the motor 8 as a two-input and two-output transfer system. The motor model 40 has as its inputs a terminal voltage V of the motor 8 and a load torque τ acting on the motor 8, and has as its outputs a current i flowing through the motor 8 and the rotation speed ω of the motor 8. It should be noted that the terminal voltage V of the motor 8, the load torque τ acting on the motor 8, the current i flowing through the motor 8, and the rotation speed ω of the motor 8 are hereinafter referred to also as state quantities of the motor 8.

The characteristics of the motor model 40 can be determined based on the input-output characteristics of the actual motor 8. For example, when the motor 8 is a DC motor, the characteristics of the motor model 40 can be determined in the following way.

For the electrical system of the motor 8, when L is the inductance, i is the current, V is the terminal voltage, R is the resistance, KB is the power generation constant, and ω is the rotation speed, the following relational expression holds:

$$L \frac{d i}{d t} = V - Ri - KB ω \qquad ( 1 )$$

For the mechanical system of the motor 8, on the other hand, when J is the inertia moment of the rotor, KT is the torque constant, B is the friction constant, and τ is the load torque, the following relational expression holds:

$$J \frac{d ω}{dt} = KTi - B ω - τ \qquad ( 2 )$$

It should be noted that in this specification, the left-hand side of Mathematical Expression (2) is referred to as the inertia torque, and the first, second, and third terms of the right-hand side of Mathematical Expression (2) are referred to as the output torque, the friction torque, and the load torque, respectively.

Integrating both sides of Mathematical Expressions (1) and (2) with respect to time gives the following two relational expressions:

$$\begin{matrix}i = \int ( \frac{1}{L} V - \frac{R}{L} i - \frac{KB}{L} ω ) d t & ( 3 ) \\ ω = \int ( \frac{KT}{J} i - \frac{B}{J} ω - \frac{1}{J} τ ) d t & ( 4 )\end{matrix}$$

Performing numerical calculations based on Mathematical Expressions (3) and (4) gives two outputs i and ω with respect to two inputs V and τ. As can be seen from the above, when the motor model 40 is configured to have as its inputs the terminal voltage V of the motor 8 and the load torque τ acting on the motor 8 and have as its outputs the current i flowing through the motor 8 and the rotation speed ω of the motor 8, each of the outputs can be obtained by integral calculation without performing differential calculation. In general, when the load torque estimation circuit 16 is for example a microcomputer mounted on a single chip, it is difficult to perform differential calculation with high accuracy when there is an abrupt change in state quantity of the motor 8. However, by constructing the motor model 40 such that the outputs are obtained by integral calculation as stated above, the behavior of the motor 8 can be simulated with high accuracy even when there is an abrupt change in state quantity of the motor 8.

As shown in FIG. 3, a current output from the motor model 40, i.e. an estimated value iₑ of the current flowing through the motor 8, is provided to the comparator 42. The comparator 42 calculates a difference Δi between the measured value iₘ of the current flowing through the motor 8 and the current output iₑ from the motor model 40. The difference Δi thus calculated is amplified by a predetermined gain G in the amplifier 44 and then inputted to the torque input of the motor model 40 as the estimated value τₑ of the load torque acting on the motor 8. In this way, the load torque estimation circuit 16 constitutes a feedback loop. It should be noted that as a voltage input of the motor model 40, the measured value Vₘ of the terminal voltage of the motor 8 is inputted.

In the feedback loop, by setting the gain G in the amplifier 44 sufficiently high in advance, the input torque to the motor model 40, i.e. the magnitude of the estimated value τₑ of the load torque acting on the motor 8, is adjusted so that the current output from the motor model 40, i.e. the estimated value iₑ of the current flowing through the motor 8, converges to the measured value iₘ of the current flowing through the motor 8. This configuration makes it possible to use the motor model 40 to so calculate the load torque τₑ acting on the motor 8 and a rotation speed ωₑ of the motor 8 then, that the current iₘ flowing through the motor 8 is achieved when the terminal voltage Vₘ is applied to the motor 8.

The principle of the estimation of the load torque τ acting on the motor 8 by the load torque estimation circuit 16 is explained with reference to FIG. 4. In FIG. 4, the actual motor 8 is expressed as a transfer function M₁, and the motor model 40, which is a virtual realization of the motor 8 in the load torque estimation circuit 16, is expressed as a transfer function M₂. The relationship between an input τ₁ (i.e. the value of the load torque acting on the actual motor 8) to the control system shown in FIG. 3 and an output τ₂ (i.e. an estimated value of a torque that is outputted from the load torque estimation circuit 16) from the control system shown in FIG. 3 is as follows:

$${τ}_{2} = \frac{{GM}_{1}}{1 + {GM}_{2}} {τ}_{1} \qquad ( 5 )$$

Therefore, setting the motor model 40 in the load torque estimation circuit 16 in advance to be equivalent in characteristics to the actual motor 8 makes it possible to substitute M₁=M₂=M in Mathematical Expression (5), thereby giving the following relational expression:

$${τ}_{2} = \frac{{GM}_{1}}{1 + GM} {τ}_{1} \qquad ( 6 )$$

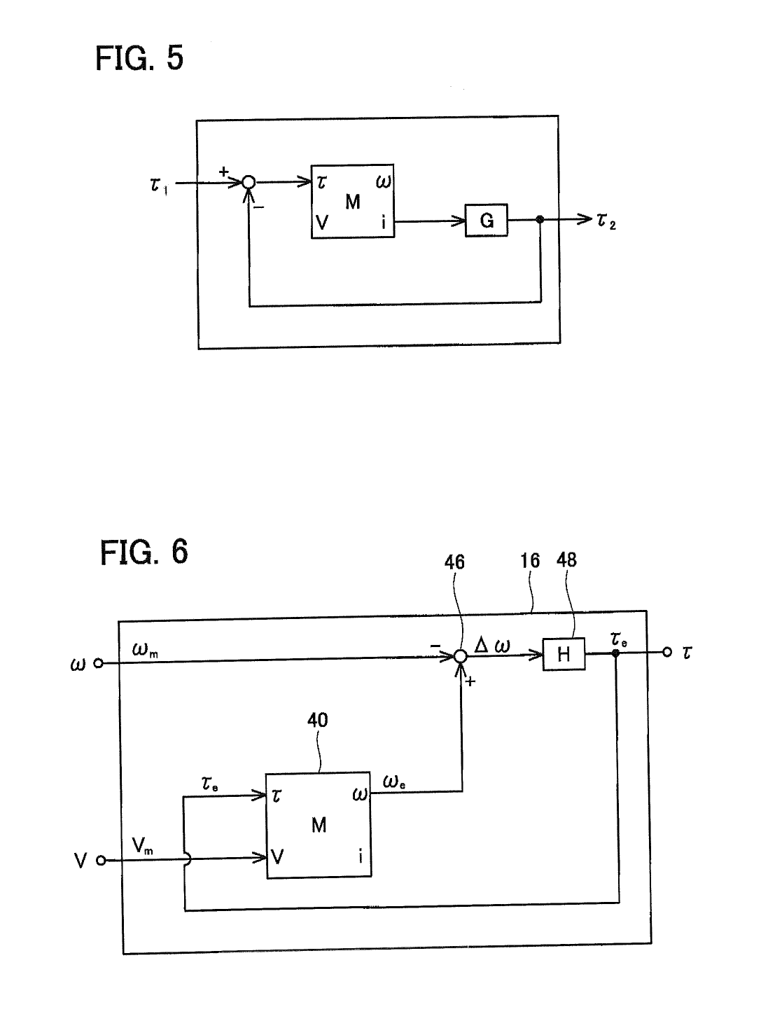

As can be seen from Mathematical Expression (6), a transfer function from the input τ₁ to the output τ₂ of the control system of FIG. 4 is equivalent to that of a feedback control system, such as that shown in FIG. 5, in which the forward transfer function is GM and the backward transfer function is 1. Therefore, the output τ₂ changes according to the input τ₁. Setting the gain G in the amplifier 44 sufficiently high in advance causes the output τ₂ to converge to the input τ₁. Therefore, the load torque τ₁ acting on the motor 8 can be found from the estimated value τ₂ of the torque that is outputted from the load torque estimation circuit 16.

The load torque estimation circuit 16 of the present embodiment makes it possible, without providing a dedicated sensor for detecting a torque, to estimate the load torque τ acting on the motor 8 with high accuracy based on the terminal voltage V of the motor 8 and the current i flowing through the motor 8.

The load torque estimation circuit 16 of the present embodiment is configured to use the feedback loop including the motor model 40, which has as its inputs the terminal voltage V of the motor 8 and the load torque z acting on the motor 8 and has as its outputs the current i flowing through the motor 8 and the rotation speed ω of the motor 8, to cause the current output iₑ from the motor model 40 to converge to the current iₘ flowing through the actual motor 8. This configuration makes it possible, without using differential calculation, to estimate the load torque τ acting on the motor 8 with high accuracy.

FIG. 6 shows another example of a configuration of a load torque estimation circuit 16. The load torque estimation circuit 16 of FIG. 6 is configured to output an estimated value τₑ of the load torque acting on the motor 8 based on a measured value ωₘ of the rotation speed of the motor 8 as detected by the rotation speed sensor 12 and the measured value Vₘ of the terminal voltage of the motor 8 as detected by the voltage detection unit 32. The load torque estimation circuit 16 of FIG. 6 includes a motor model 40, a comparator 46, and an amplifier 48.

The motor model 40 of the load torque estimation circuit 16 of FIG. 6 is identical to the motor model 40 of the load torque estimation circuit 16 of FIG. 3. In the load torque estimation circuit 16 of FIG. 6, a rotation speed output from the motor model 40, i.e. an estimated value ωₑ of the rotation speed of the motor 8, is provided to the comparator 46. The comparator 46 calculates a difference Δω between the rotation speed output ωₑ from the motor model 40 and the measured value ωₘ of the rotation speed of the motor 8. The difference Δω thus calculated is amplified by a predetermined gain H in the amplifier 48 and then inputted to the torque input of the motor model 40 as the estimated value τₑ of the load torque acting on the motor 8. As the voltage input of the motor model 40, the measured value Vₘ of the terminal voltage of the motor 8 is inputted.

In the feedback loop of the load torque estimation circuit 16 of FIG. 6, by setting the gain H in the amplifier 48 sufficiently high in advance, the input torque to the motor model 40, i.e. the magnitude of the estimated value τₑ of the load torque acting on the motor 8, is adjusted so that the rotation speed output from the motor model 40, i.e. the estimated value ωₑ of the rotation speed of the motor 8, converges to the measured value ωₘ of the rotation speed of the motor 8. This configuration makes it possible to use the motor model 40 to so estimate the load torque τₑ acting on the motor 8 that the rotation speed ωₘ of the motor 8 is achieved when the terminal voltage Vₘ is applied to the motor 8.

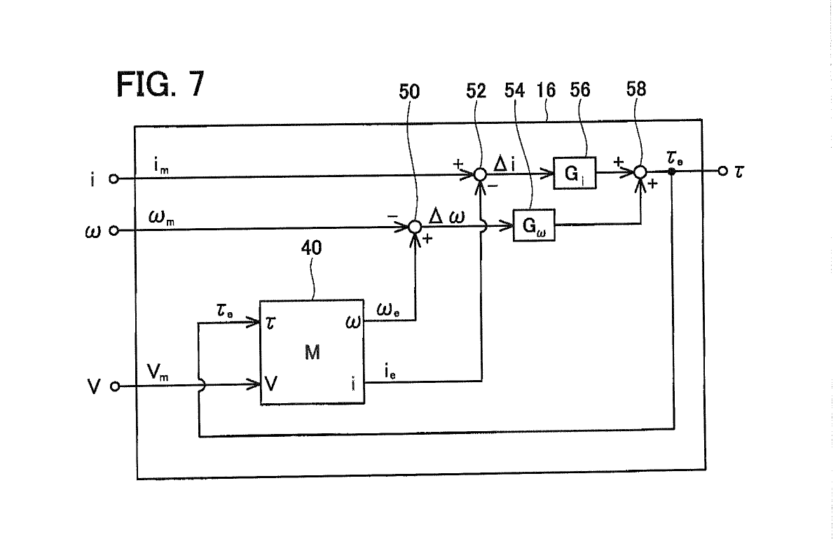

FIG. 7 shows still another example of a configuration of a load torque estimation circuit 16. The load torque estimation circuit 16 of FIG. 7 is configured to output an estimated value τₑ of the load torque acting on the motor 8 based on the measured value iₘ of the current flowing through the motor 8 as detected by the current detection unit 30, the measured value ωₘ of the rotation speed of the motor 8 as detected by the rotation speed sensor 12, and the measured value Vₘ of the terminal voltage of the motor 8 as detected by the voltage detection unit 32. The load torque estimation circuit 16 of FIG. 7 includes a motor model 40, comparators 50 and 52, and amplifiers 54 and 56, and an adder 58.

The motor model 40 of the load torque estimation circuit 16 of FIG. 7 is identical to the motor model 40 of the load torque estimation circuit 16 of FIG. 3. In the load torque estimation circuit 16 of FIG. 7, the rotation speed output from the motor model 40, i.e. the estimated value ωₑ of the rotation speed of the motor 8, is provided to the comparator 50. The comparator 50 calculates the difference Δω between the rotation speed output ωₑ from the motor model 40 and the measured value ωₘ of the rotation speed of the motor 8. The difference Δω thus calculated is amplified by a predetermined gain G_{ω} in the amplifier 54 and then provided to the adder 58. Furthermore, in the load torque estimation circuit 16 of FIG. 7, the current output from the motor model 40, i.e. the estimated value iₑ of the current flowing through the motor 8, is provided to the comparator 52. The comparator 52 calculates the difference Δi between the measured value iₘ of the current flowing through the motor 8 and the current output iₑ from the motor model 40. The difference Δi thus calculated is amplified by a predetermined gain Gᵢ in the amplifier 56 and then provided to the adder 58. The adder 58 adds together the output from the amplifier 54 and the output from the amplifier 56. The output from the adder 58 is inputted to the torque input of the motor model 40 as the estimated value τₑ of the load torque acting on the motor 8. To the voltage input of the motor model 40, the measured value Vₘ of the terminal voltage of the motor 8 is inputted.

In the feedback loop of the load torque estimation circuit 16 of FIG. 7, by setting the gain G_{ω} in the amplifier 54 and the gain Gᵢ in the amplifier 56 sufficiently high in advance, the input torque to the motor model 40, i.e. the magnitude of the estimated value τₑ of the load torque acting on the motor 8, is adjusted so that the rotation speed output from the motor model 40, i.e. the estimated value ωₑ of the rotation speed of the motor 8, converges to the measured value ωₘ of the rotation speed of the motor 8 and so that the current output from the motor model 40, i.e. the estimated value iₑ of the current flowing through the motor 8, converges to the measured value iₘ of the current flowing through the motor 8. This configuration makes it possible to use the motor model 40 to so estimate the load torque τₑ acting on the motor 8 that the current iₘ flowing through the motor 8 and the rotation speed ωₘ of the motor 8 are achieved when the terminal voltage Vₘ is applied to the motor 8.

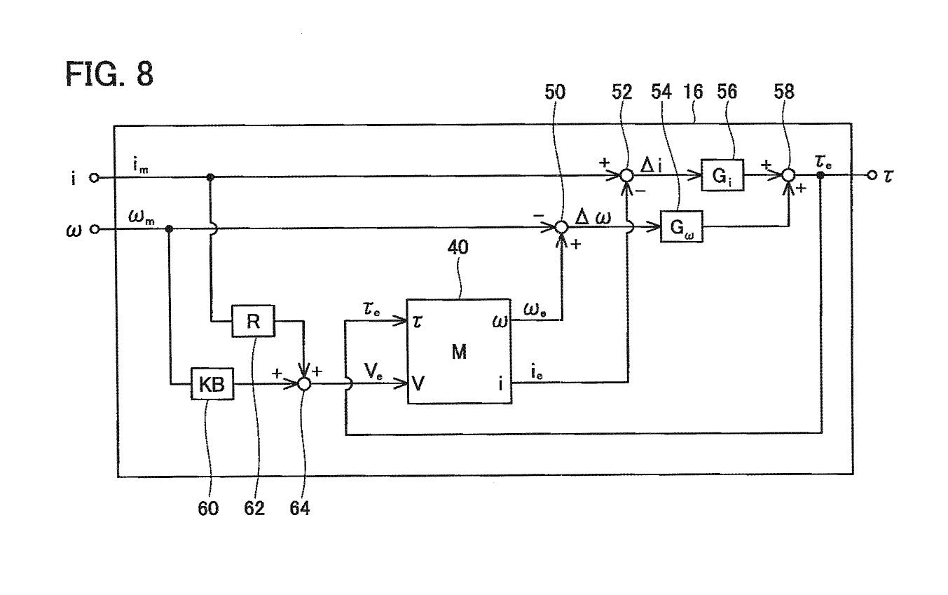

FIG. 8 shows still another example of a configuration of a load torque estimation circuit 16. The load torque estimation circuit 16 of FIG. 8 is configured to output an estimated value τₑ of the load torque acting on the motor 8 based on the measured value iₘ of the current flowing through the motor 8 as detected by the current detection unit 30 and the measured value ωₘ of the rotation speed of the motor 8 as detected by the rotation speed sensor 12. The load torque estimation circuit 16 of FIG. 8 includes a motor model 40, comparators 50 and 52, and amplifiers 54 and 56, an adder 58, amplifiers 60 and 62, and an adder 64.

The load torque estimation circuit 16 of FIG. 8 includes substantially the same components as those of the load torque estimation circuit 16 of FIG. 7. In the load torque estimation circuit 16 of FIG. 8, the measured value Vₘ of the terminal voltage of the motor 8 is not inputted to the voltage input of the motor model 40, but instead an estimated value Vₑ of the terminal voltage of the motor 8 as calculated from the measured value iₘ of the current flowing through the motor 8 and the measured value ωₘ of the rotation speed of the motor 8 is inputted to the voltage input of the motor model 40. In the load torque estimation circuit 16 of FIG. 8, the estimated value Vₑ of the terminal voltage of the motor 8 is calculated by approximating Ldi/dt on the left-hand side of Mathematical Expression (1) to zero. That is, in the load torque estimation circuit 16 of FIG. 8, the estimated value Vₑ of the terminal voltage of the motor 8 is calculated by adding together a value obtained by multiplying the measured value iₘ of the current flowing through the motor 8 by the resistance R of the motor 8 and a value obtained by multiplying the measured value ωₘ of the rotation speed of the motor 8 by the power generation constant KB of the motor 8.

It should be noted that the load torque estimation circuit 16 may be mounted as a circuit that is separate from the controller 18 or may be incorporated into the controller 18.

The mode switching unit 20 of FIG. 1 allows the user to carry out an operation of switching from one operation mode of the power tool 2 to another. The power tool 2 of the present embodiment is switchable among a driver mode, a drill mode, and a vibratory drill mode. The mode switching unit 20 may be provided, for example, in the form of a dial, a slide switch, or the like. The mode switching unit 20 may be provided, for example, near the tool unit 4, may be provided near a back surface of the power tool 2 (opposite side of the tool unit 4), or may be provided near the battery 10.

The torque setting unit 22 allows the user to carry out an operation of switching between turning on a torque limiter function and turning off the torque limiter function and an operation of setting the after-mentioned inertia torque reference value τᵢᵣ, the after-mentioned load torque reference value τₗᵣ, and the after-mentioned load torque upper limit value τₗᵤ. The torque setting unit 22 may be provided, for example, in the form of a dial, a slide switch, or the like. In torque setting unit 22, the inertia torque reference value τᵢᵣ, the load torque reference value τₗᵣ, and the load torque upper limit value τₗᵤ may be separately settable, or a combination of the inertia torque reference value τᵢᵣ, the load torque reference value τₗᵣ, and the load torque upper limit value τₗᵤ may be selectable by the user from a plurality of combinations predetermined before product shipment. The torque setting unit 22 may be provided, for example, near the tool unit 4, may be provided near the back surface of the power tool 2 (opposite side of the tool unit 4), or may be provided near the battery 10.

The notification unit 24 is configured to notify the user when the controller 18 stops or decelerates the motor 8. The notification unit 24 may for example be an LED or the like configured to notify the user by emitting light. Alternatively, the notification unit 24 may be a buzzer or the like configured to notify the user by making a sound. In the power tool 2 of the present embodiment, the notification unit 24 is an LED. The notification unit 24 may be provided, for example, near the tool unit 4, may be provided near the back surface of the power tool 2 (opposite side of the tool unit 4), or may be provided near the battery 10.

The driving switch 26 is operated by the user. During normal operations, the motor 8 is stopped when the driving switch 26 is off, and the motor 8 is driven to rotate when the driving switch 26 is turned on.

The side handle 28 is removably attached to the power tool 2. Even when work is done at such a heavy load that a reaction torque acting on the power tool 2 from a workpiece is greater than, for example, 40 Nm, the user can stably perform the work by gripping the power tool 2 with both hands by utilizing the side handle 28.

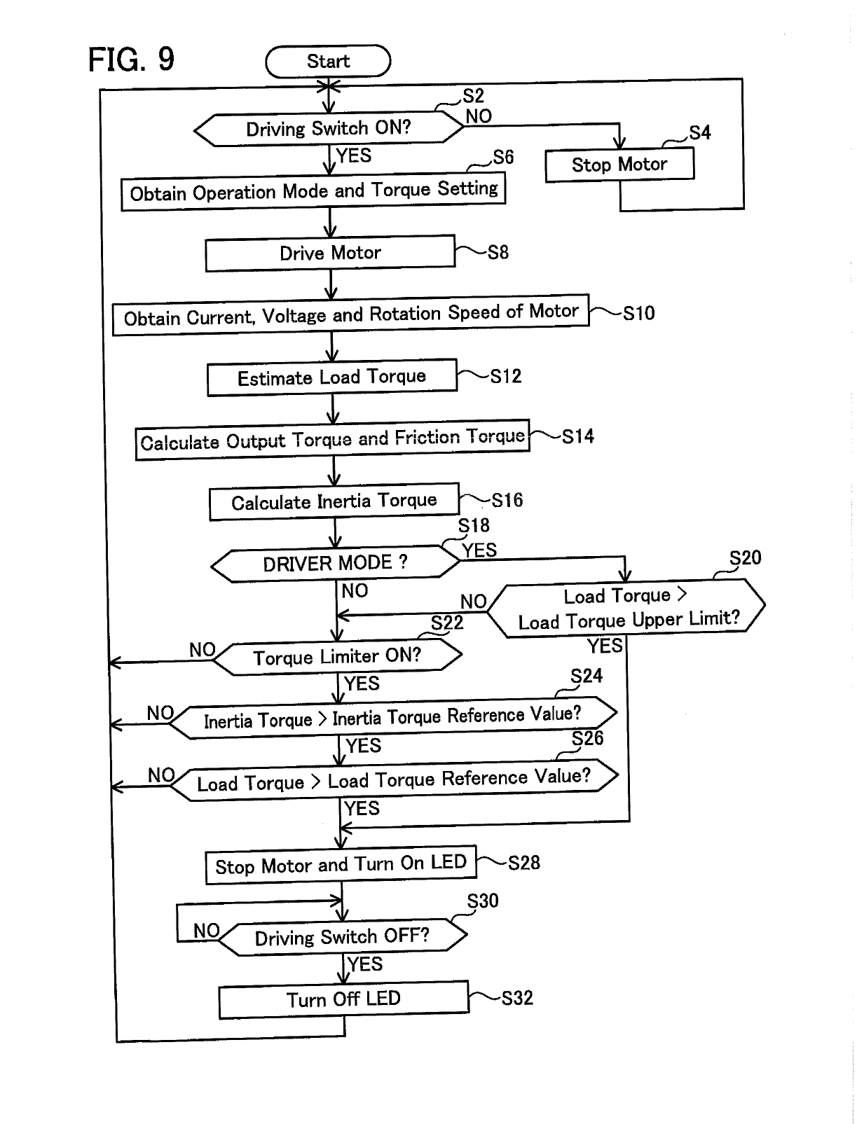

The controller 18 is configured to control operation of the power tool 2 based on the measured value ωₘ of the rotation speed of the motor 8 as detected by the rotation speed sensor 12, the measured value iₘ of the current flowing through the motor 8 as detected by the current detection unit 30, and the estimated value τₑ of the load torque acting on the motor 8 as calculated by the load torque estimation circuit 16. A process that is performed by the controller 18 is described below with reference to FIG. 9.

In step S2, the controller 18 determines whether or not the driving switch 26 is on. When the driving switch 26 is off (when NO in step S2), the process proceeds to step S4. In step S4, if the motor 8 is being driven, the controller 18 stops the motor 8. After step S4, the process returns to step S2.

When, in step S2, the driving switch 26 is on (when YES), the process proceeds to step S6. In step S6, the controller 18 obtains an operation mode from the mode switching unit 20. Further, in step S6, the controller 18 obtains the on/off of the torque limiter function, the inertia torque reference value τᵢᵣ, the load torque reference value τₗᵣ, and the load torque upper limit value τₗᵤ from the torque setting unit 22.

In step S8, the controller 18 drives the motor 8 to rotate.

In step S10, the controller 18 obtains, from the current detection unit 30, the measured value iₘ of the current flowing through the motor 8. Further, in step S10, the controller 18 obtains the measured value Vₘ of the terminal voltage of the motor 8 from the voltage detection unit 32. Furthermore, in step S10, the controller 18 obtains the measured value ωₘ of the rotation speed of the motor 8 from the rotation speed sensor 12.

In step S12, the controller 18 obtains, from the load torque estimation circuit 16, the estimated value τₑ of the load torque acting on the motor 8.

In step S14, the controller 18 calculates an output torque KTi of the motor 8 by multiplying the measured value iₘ of the current flowing through the motor 8 obtained in step S10 by the torque constant KT. Further, in step S14, the controller 18 calculates a friction torque Bω of the motor 8 by multiplying the measured value ωₘ of the rotation speed of the motor 8 obtained in step S10 by the friction constant B.

In step S16, the controller 18 calculates an inertia torque −Jdω/dt of the motor 8 according to Mathematical Expression (2) by subtracting the output torque KTi of the motor 8 from the estimated value τₑ of the load torque acting on the motor 8 and adding the friction torque Bω of the motor 8. It should be noted here that since the inertia torque is a force that acts in a direction opposite to the direction of acceleration and deceleration to keep the velocity at each point in time, a negative sign is taken into consideration.

In step S18, the controller 18 determines whether or not the operation mode obtained in step S6 is the driver mode. When the operation mode is the driver mode (when YES in step S18), the process proceeds to step S20. When the operation mode is not the drive mode (when NO in step S18), e.g. when the operation mode is the drill mode or the vibratory drill mode, the process proceeds to step S22.

In step S20, the controller 18 determines whether or not the estimated value τₑ of the load torque obtained in step S12 is greater than the load torque upper limit value τₗᵤ. When the estimated value τₑ of the load torque is greater than the load torque upper limit value τₗᵤ (when YES in step S20), the process proceeds to step S28. When the estimated value τₑ of the load torque is not greater than the load torque upper limit value τₗᵤ (when NO in step S20), the process proceeds to step S22.

In step S22, the controller 18 determines whether or not the torque limiter function is on. When the torque limiter function is off (when NO in step S22), the process returns to step S2. When the torque limiter function is on (when YES in step S22), the process proceeds to step S24.

In step S24, the controller 18 determines whether or not the inertia torque −Jdω/dt calculated in step S16 is greater than the inertia torque reference value τᵢᵣ. When the inertia torque −Jdω/dt is not greater than the inertia torque reference value τᵢᵣ (when NO in step S24), the process returns to step S2. When the inertia torque −Jdω/dt is greater than the inertia torque reference value τᵢᵣ (when YES in step S24), the process proceeds to step S26.

In step S26, the controller 18 determines whether or not the estimated value τₑ of the load torque estimated in step S12 is greater than the load torque reference value τₗᵣ. When the estimated value τₑ of the load torque is not greater than the load torque reference value τₗᵣ (when NO in step S26), the process returns to step S2. When the estimated value τₑ of the load torque is greater than the load torque reference value τₗᵣ (when YES in step S26), the process proceeds to step 528.

In step S28, the controller 18 stops the motor 8. Further, in step 528, the controller 18 turns on the LED serving as the notification unit 24.

In step S30, the controller 18 waits until the driving switch 26 is turned off. When the driving switch 26 is turned off (when YES in step S30), the process proceeds to step S32.

In step S32, the controller 18 turns off the LED serving as the notification unit 24. After step S32, the process returns to step S2.

In the power tool 2, the motor 8 is stopped when the inertia torque −Jdω/dt calculated in step S16 is greater than the inertia torque reference value τᵢᵣ and when the estimated value τₑ of the load torque obtained in step S12 is greater than the load torque reference value τₗᵣ. This makes it possible to automatically stop the motor 8 when an abrupt rise in load due to the occurrence of a kickback or the like causes an increase in the inertia torque −Jdω/dt, thus making it possible to ensure the safety of the user.

In the power tool 2, the motor 8 is not stopped when the estimated value τₑ of the load torque obtained in step S12 is not greater than the load torque reference value τₗᵣ, even when the inertia torque −Jdω/dt calculated in step S16 is greater than the inertia torque reference value τᵢᵣ. This makes it possible to improve working efficiency by preventing the motor 8 from stopping during low-load work in which an increase in inertia torque due to an abrupt rise in load, if any, is less of a problem for the safety.

In the power tool 2, the motor 8 is stopped when the driver mode is selected as the operation mode and when the estimated value τₑ of the load torque is greater than the load torque upper limit value τₗᵤ. This makes it possible to achieve the function of a driver completing screw tightening at a predetermined torque, as in the case where a mechanical clutch is used. As compared with the mechanical clutch, the electric clutch thus achieved neither generates sounds during operation nor deteriorates due to wearing. It should be noted that in the power tool 2, the motor 8 is not stopped when the drill mode or the vibratory drill mode is selected as the operation mode, even when the estimated value τₑ of the load torque is greater than the load torque upper limit value τₗᵤ. This makes it possible to improve working efficiency by preventing the motor 8 from stopping in an operation mode in which the user recognizes in advance that a high load torque will act on the motor 8.

It should be noted that the controller 18 may be configured to compare the output torque KTi calculated in step S14 to an output torque reference value τₒᵣ in step S26, instead of comparing the estimated value τₑ of the load torque to the load torque reference value τₗᵣ. In this case, when the output torque KTi is greater than the output torque reference value τₒᵣ in step S26, the process proceeds to step S28. When the output torque KTi is not greater than the output torque reference value τₒᵣ, the process returns to step S2. This configuration makes it possible to set the output torque reference value τₒᵣ instead of the load torque reference value τₗᵣ via the torque setting unit 22.

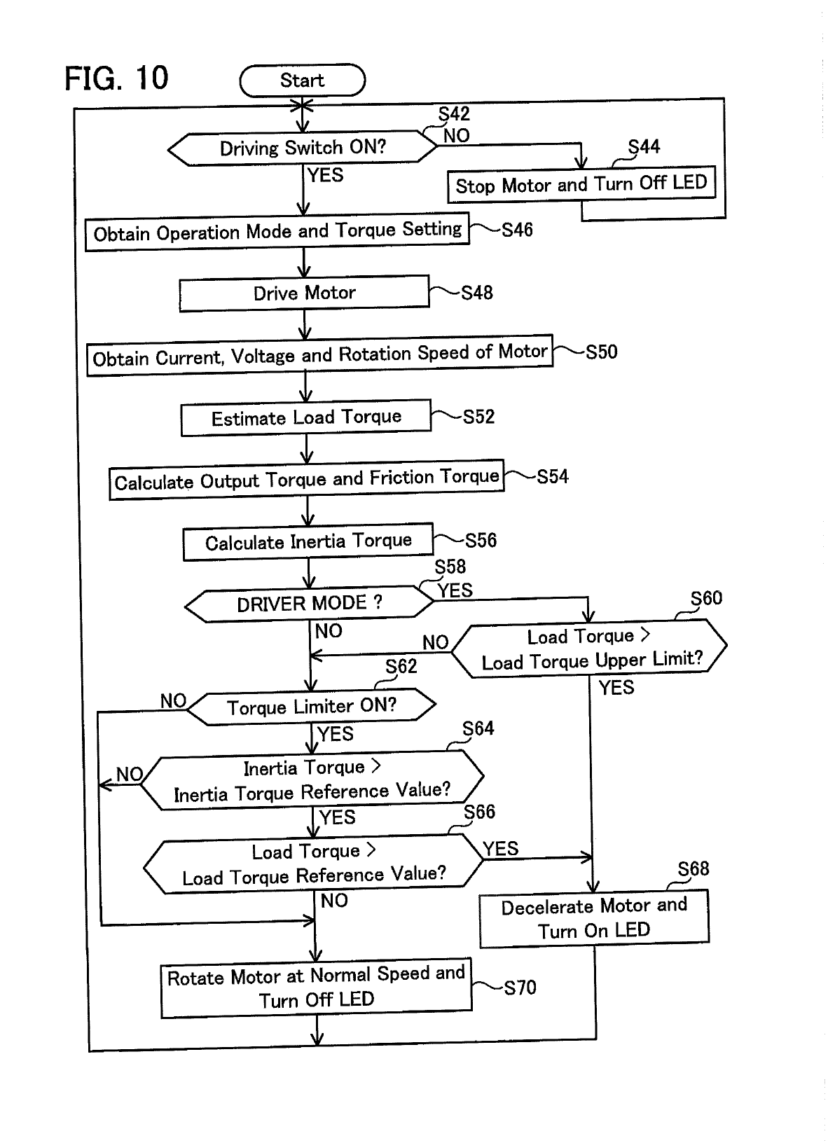

In the process shown in FIG. 9, the motor 8 is automatically stopped according to the magnitude of the inertia torque or the load torque. Alternatively, the controller 18 may be configured to make the motor 8 slower than normal instead of stopping the motor 8. A process that is performed by the controller 18 in such a case is described below with reference to FIG. 10.

In step S42, the controller 18 determines whether or not the driving switch 26 is on. When the driving switch 26 is off (when NO in step S42), the process proceeds to step S44. In step S44, if the motor 8 is being driven, the controller 18 stops the motor 8. Further, in step S44, if the LED serving as the notification unit 24 is on, the controller 18 turns off the LED serving as the notification unit 24. After step S44, the process returns to step S42.

When, in step S42, the driving switch 26 is on (when YES), the process proceeds to step S46. In step S46, the controller 18 obtains an operation mode from the mode switching unit 20. Further, in step S46, the controller 18 obtains the on/off of the torque limiter function, the inertia torque reference value τᵢᵣ, the load torque reference value τₗᵣ, and the load torque upper limit value τₗᵤ from the torque setting unit 22.

In step S48, the controller 18 drives the motor 8 to rotate.

In step S50, the controller 18 obtains, from the current detection unit 30, the measured value iₘ of the current flowing through the motor 8. Further, in step S50, the controller 18 obtains the measured value Vₘ of the terminal voltage of the motor 8 from the voltage detection unit 32. Furthermore, in step S50, the controller 18 obtains the measured value ωₘ of the rotation speed of the motor 8 from the rotation speed sensor 12.

In step S52, the controller 18 obtains, from the load torque estimation circuit 16, the estimated value τₑ of the load torque acting on the motor 8.

In step S54, the controller 18 calculates an output torque KTi of the motor 8 by multiplying the measured value iₘ of the current flowing through the motor 8 obtained in step S50 by the torque constant KT. Further, in step S54, the controller 18 calculates a friction torque Bω of the motor 8 by multiplying the measured value ωₘ of the rotation speed of the motor 8 obtained in step S50 by the friction constant B.

In step S56, the controller 18 calculates an inertia torque −Jdω/dt of the motor 8 according to Mathematical Expression (2) by subtracting the output torque KTi of the motor 8 from the estimated value τₑ of the load torque acting on the motor 8 and adding the friction torque Bω of the motor 8. It should be noted here that since the inertia torque is a force that acts in a direction opposite to the direction of acceleration and deceleration to keep the velocity at each point in time, a negative sign is taken into consideration.

In step S58, the controller 18 determines whether or not the operation mode obtained in step S46 is the driver mode. When the operation mode is the driver mode (when YES in step S58), the process proceeds to step S60. When the operation mode is not the drive mode (when NO in step S58), e.g. when the operation mode is the drill mode or the vibratory drill mode, the process proceeds to step S62.

In step S60, the controller 18 determines whether or not the estimated value τₑ of the load torque obtained in step S52 is greater than the load torque upper limit value τₗᵤ, When the estimated value τₑ of the load torque is greater than the load torque upper limit value τₗᵤ (when YES in step S60), the process proceeds to step S68. When the estimated value τₑ of the load torque is not greater than the load torque upper limit value τₗᵤ (when NO in step S60), the process proceeds to step S62.

In step S62, the controller 18 determines whether or not the torque limiter function is on. When the torque limiter function is off (when NO in step S62), the process proceeds to step S70. When the torque limiter function is on (when YES in step S62), the process proceeds to step S64.

In step 564, the controller 18 determines whether or not the inertia torque −Jdω/dt calculated in step S56 is greater than the inertia torque reference value τᵢᵣ. When the inertia torque −Jdω/dt is not greater than the inertia torque reference value τᵢᵣ (when NO in step S64), the process proceeds to step S70. When the inertia torque −Jdω/dt is greater than the inertia torque reference value τᵢᵣ (when YES in step S64), the process proceeds to step S66.

In step S66, the controller 18 determines whether or not the estimated value τₑ of the load torque estimated in step S52 is greater than the load torque reference value τₗᵣ. When the estimated value τₑ of the load torque is not greater than the load torque reference value τₑ (when NO in step S66), the process proceeds to step S70. When the estimated value τₑ of the load torque is greater than the load torque reference value τₗᵣ (when YES in step S66), the process proceeds to step S68.

In step S68, if the motor 8 is rotating at a normal speed, the controller 18 decelerates the motor 8. Further, in step S68, if the LED serving as the notification unit 24 is off, the controller 18 turns on the LED serving as the notification unit 24. After step S68, the process returns to step S42.

In step S70, if the motor 8 is rotating at a lower speed than normal, the controller 18 causes the motor 8 to return to the normal speed. Further, in step S70, if the LED serving as the notification unit 24 is on, the controller 18 turns off the LED serving as the notification unit 24. After step S70, the process returns to step S42.

It should be noted that, the controller 18 may be configured to compare the output torque KTi calculated in step S54 to an output torque reference value τₒᵣ in step S66, instead of comparing the estimated value τₑ of the load torque to the load torque reference value τₗᵣ.

In the embodiment described above, the measured value ωₘ of the rotation speed of the motor 8 as measured by the rotation speed sensor 12 is used for the controller 18 to calculate the friction torque Bω of the motor 8. Unlike in the embodiment described above, the load torque estimation circuit 16 shown, for example, in FIG. 3 may be configured such that the rotation speed output from the motor model 40 is outputted to the controller 18 as the estimated value ωₑ of the rotation speed of the motor 8 and the controller 18 calculates the friction torque Bω of the motor 8 from the estimated value ωₑ of the rotation speed of the motor 8.

In the embodiment described above, the measured value iₘ of the current flowing through the motor 8 as measured by the current detection unit 30 is used for the controller 18 to calculate the output torque KTi of the motor 8. Unlike in the embodiment described above, the load torque estimation circuit 16 shown, for example, in FIG. 6 may be configured such that the current output from the motor model 40 is outputted to the controller 18 as the estimated value iₑ of the current flowing through the motor 8 and the controller 18 calculates the output torque KTi of the motor 8 from the estimated value iₑ of the current flowing through the motor 8.

What is claimed is:

1. A power tool, comprising:
a motor;
an output torque calculation unit configured to calculate an output torque of the motor based on a current flowing through the motor;
a friction torque calculation unit configured to calculate a friction torque of the motor based on a rotation speed of the motor;
a load torque estimation unit configured to estimate a load torque acting on the motor;
an inertia torque calculation unit configured to calculate an inertia torque based on the output torque, the friction torque and the load torque; and
a motor deceleration unit configured to stop or decelerate the motor when the inertia torque is greater than an inertia torque reference value.

2. The power tool as in claim 1, wherein
the load torque estimation unit is configured to estimate the load torque based on at least two of a measured value of the current flowing through the motor, a measured value of a terminal voltage of the motor and a measured value of the rotation speed of the motor.

3. The power tool as in claim 1, further comprising
a rotation speed estimation unit configured to estimate the rotation speed of the motor based on a measured value of the current flowing through the motor and a measured value of a terminal voltage of the motor.

4. The power tool as in claim 1, wherein
the motor deceleration unit is configured not to stop or decelerate the motor when the load torque is less than a load torque reference value or the output torque is less than an output torque reference value, even when the inertia torque is greater than the inertia torque reference value.

5. The power tool as in claim 4, wherein a combination of the load torque reference value or the output torque reference value and the inertia torque reference value is selectable from a plurality of predetermined combinations by a user.

6. The power tool as in claim 1, further comprising
a removable side handle.

7. The power tool as in claim 1, wherein
the motor is a brushless motor.

8. The power tool as in claim 1, wherein
the motor deceleration unit further configured to stop or decelerate the motor when the load torque is greater than a load torque upper limit value.

9. The power tool as in claim 8, further comprising
a mode switching unit configured to select an operation mode of the power tool from a plurality of operation modes, wherein
the motor deceleration unit configured not to stop or decelerate the motor when a specific operation mode is selected, even when the load torque is greater than the load torque upper limit value

10. The power tool as in claim 1, further comprising:
a notification unit configured to notify a user when the motor deceleration unit stops or decelerates the motor.
